(19) United States
(12) Patent Application Publication
(10) Pub. No.: US 2011/0164068 A1
(43) Pub. Date: Jul. 7, 2011

(54) REORDERING DISPLAY LINE UPDATES

(75) Inventor: MARK M. TODOROVICH, SAN DIEGO, CA (US)

(73) Assignee: QUALCOMM MEMS TECHNOLOGIES, INC., SAN DIEGO, CA (US)

(21) Appl. No.: 12/683,284

(22) Filed: Jan. 6, 2010

(51) Int. Cl. G09G 5/10

(52) U.S. Cl. 345/690

(57) ABSTRACT

An apparatus and method for driving a display. The order in which lines of a display are updated is changed in order to take advantage of potential similarities between updated data for the lines. The lines are grouped according to one or more common characteristics and one or more of the groups are updated sequentially.

### BACKGROUND

1. Field of the Invention

The present invention relates to an update scheme for a display apparatus.

2. Description of Related Technology

Electromechanical systems (EMS) include mechanical elements, actuators, and electronics. Mechanical elements may be created using deposition, etching, and or other machining processes that etch away parts of substrates and/or deposited material layers or that add layers to form electrical and electromechanical devices. One type of EMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Preferred Embodiments” one will understand how the features of this invention provide advantages over other display devices.

One aspect of the invention includes a method of updating a display. The display comprises a plurality of display elements arranged as a plurality of lines, each line having an associated color and polarity. The method includes updating one or more update sections of the display. An update section of the one or more update sections comprises one or more lines. The one or more lines of the update section are grouped as one or more update groups. Each update group comprises a subset of the one or more lines having one or more common characteristics. Updating the update section comprises updating each update group of the one or more update groups in the update section. Updating each update group comprises updating each line in the subset of the one or more lines in the update group.

Another aspect of the invention includes a display apparatus. The display apparatus includes a plurality of display elements arranged as a plurality of lines. The display apparatus also includes a processor coupled to the plurality of display elements. The processor is configured to update one or more update sections of the display. An update section of the one or more update sections comprises one or more lines. The one or more lines of the update section are grouped as one or more update groups. Each update group comprises a subset of the one or more lines having one or more common characteristics. Updating the update section comprises updating each update group of the one or more update groups in the update section. Updating each update group comprises updating each line in the subset of the one or more lines in the update group.

Another aspect of the invention includes a display apparatus. The display apparatus includes means for displaying data. The display also includes means for updating one or more update sections of the display means. An update section of the one or more update sections comprises one or more lines. The one or more lines of the update section are grouped as one or more update groups. Each update group comprises a subset of the one or more lines having one or more common characteristics. The means for updating the update section comprises means for updating each update group of the one or more update groups in the update section. The means for updating each update group comprises means for updating each line in the subset of the one or more lines in the update group.

Another aspect of the invention includes a computer-readable medium having stored thereon, computer executable instructions that, if executed by an apparatus, cause the apparatus to perform a method. The method includes updating one or more update sections of the display. An update section of the one or more update sections comprises one or more lines. The one or more lines of the update section are grouped as one or more update groups. Each update group comprises a subset of the one or more lines having one or more common characteristics. Updating the update section comprises updating each update group of the one or more update groups in the update section. Updating each update group comprises updating each line in the subset of the one or more lines in the update group.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is a system block diagram illustrating an embodiment of a display system.

FIG. 9 is an exemplary timing diagram illustrating a voltage waveform on a common line.

FIG. 10 is a system block diagram illustrating a portion of the display elements of FIG. 8.

FIGS. 11A and 11B illustrate an exemplary update schedule of the display elements of FIG. 8.

FIGS. 12A and 12B illustrate another exemplary update schedule of the display elements of FIG. 8.

FIGS. 13A and 13B illustrate another exemplary update schedule of the display elements of FIG. 8.

FIG. 14 is a flowchart of an embodiment of a process of updating the display elements of FIG. 8.

### DETAILED DESCRIPTION OF PREFERRED EMBODIMENTS

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). EMS devices of similar structure to those described herein can also be used in non-display applications such as in electronic switching devices.

Conventional approaches to reducing power consumption in EMS display devices have included various techniques that each tends to compromise the user experience by decreasing the quality of the image displayed to the user. These approaches have included decreasing the resolution or complexity of displayed images, decreasing the number of images in the sequence over a given time period, and decreasing the grayscale or color intensity depth of the image. Other suggestions have been made to reduce power consumption by different methods of addressing the display, however, they have been too complex, such that they require more power to solve the computation than power saved from the addressing of the display. Methods and devices are described herein which are configured to reduce power consumption by determining a row-addressing order based on attributes of the image data, and reducing the number of column charging transitions necessary to write an image to the display. One embodiment provides a method of efficiently computing a row-addressing order for a display device and addressing the display.

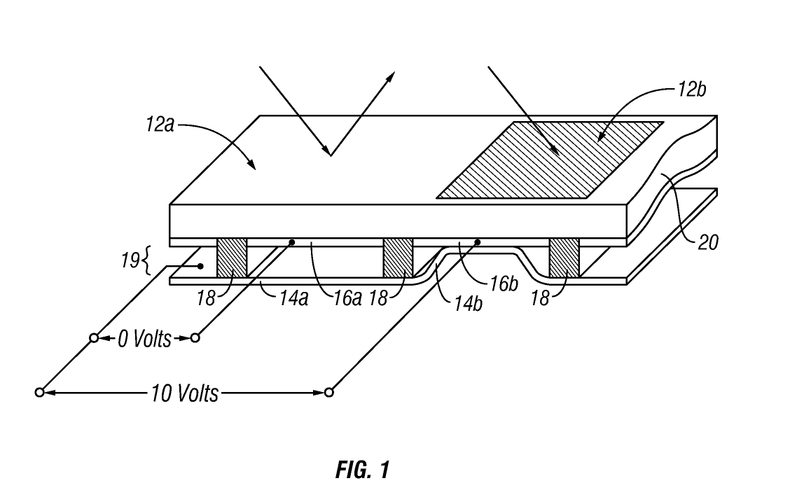

One interferometric modulator display embodiment comprising an interferometric EMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. EMS pixels can be configured to reflect predominantly at selected colors, allowing for a color display in addition to black and white.

FIG. 1 is an isometric view depicting two adjacent pixels in a series of pixels of a visual display, wherein each pixel comprises a EMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form column electrodes in a display device as described further below. The movable reflective layers 14a, 14b may be formed as a series of parallel strips of a deposited metal layer or layers (orthogonal to the column electrodes of 16a, 16b) to form rows deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form row electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

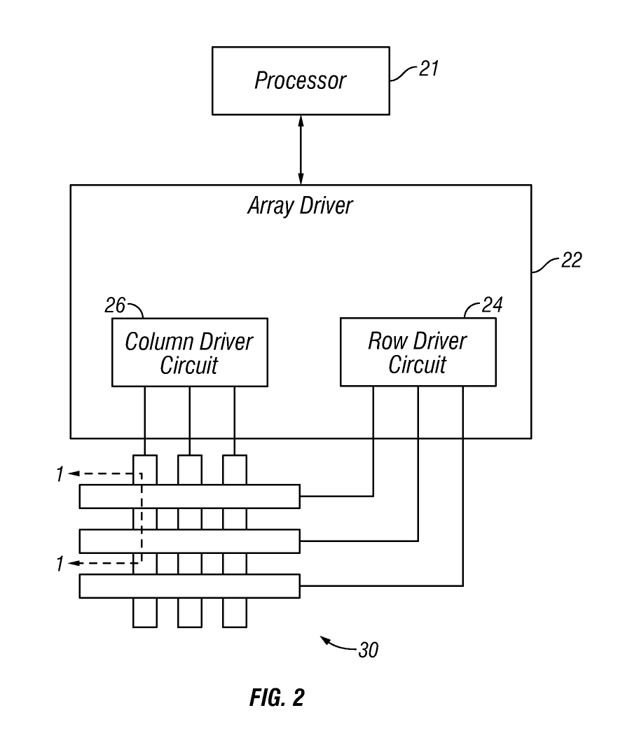

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

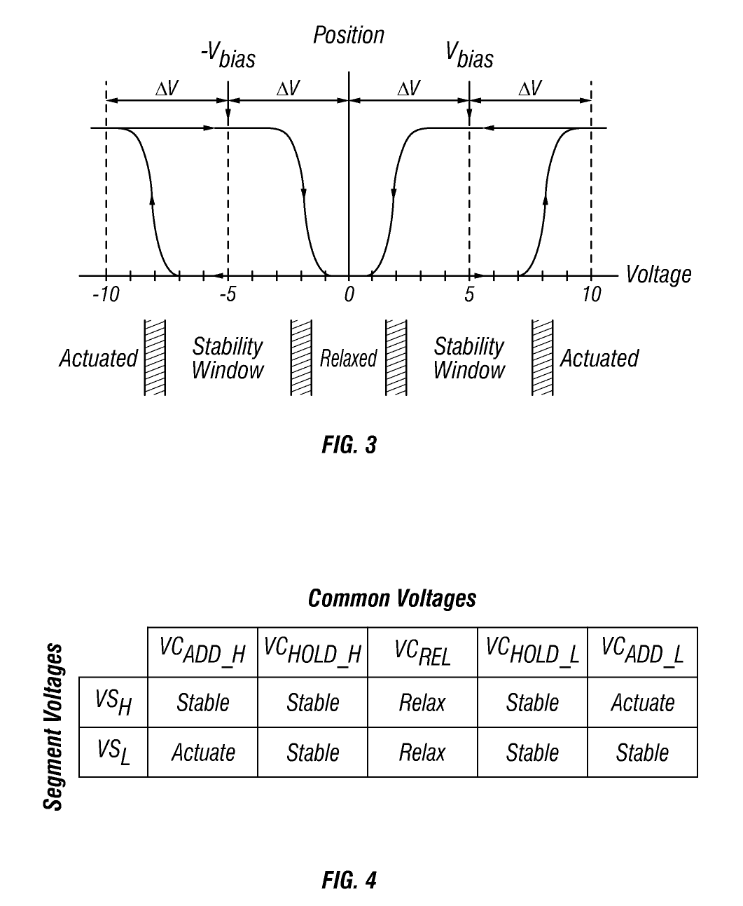

FIG. 3 is a diagram of movable mirror position versus applied voltage for one exemplary embodiment of an interferometric modulator of FIG. 1. For EMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

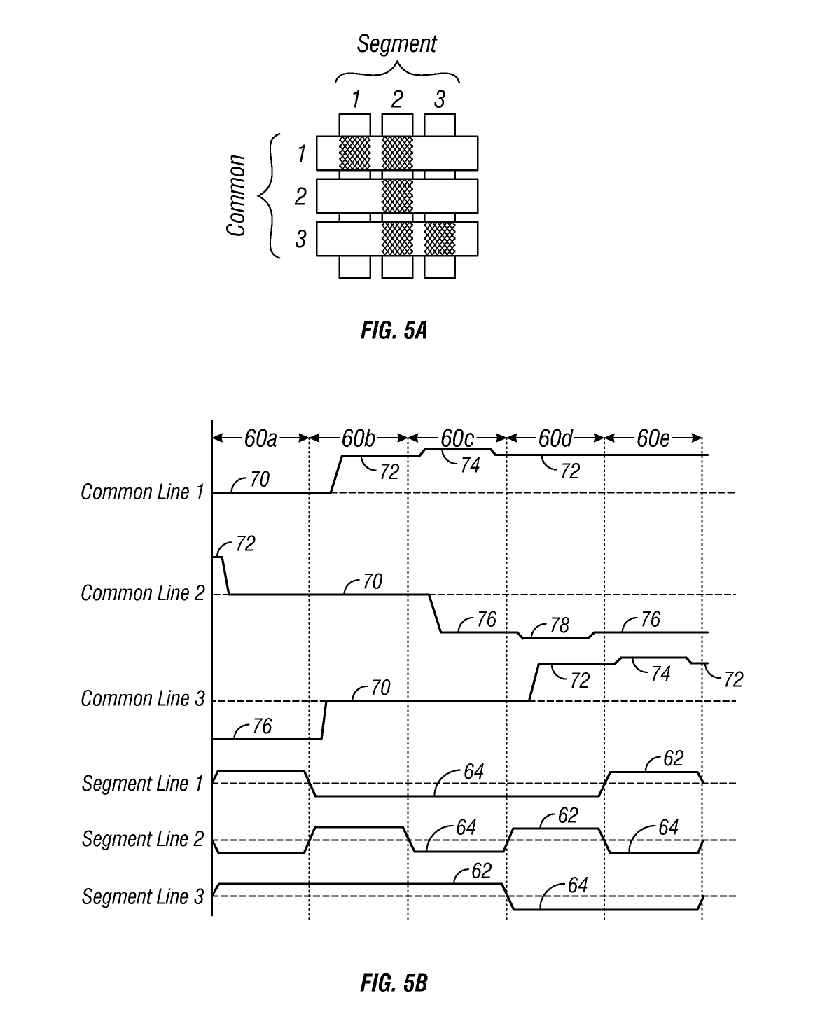

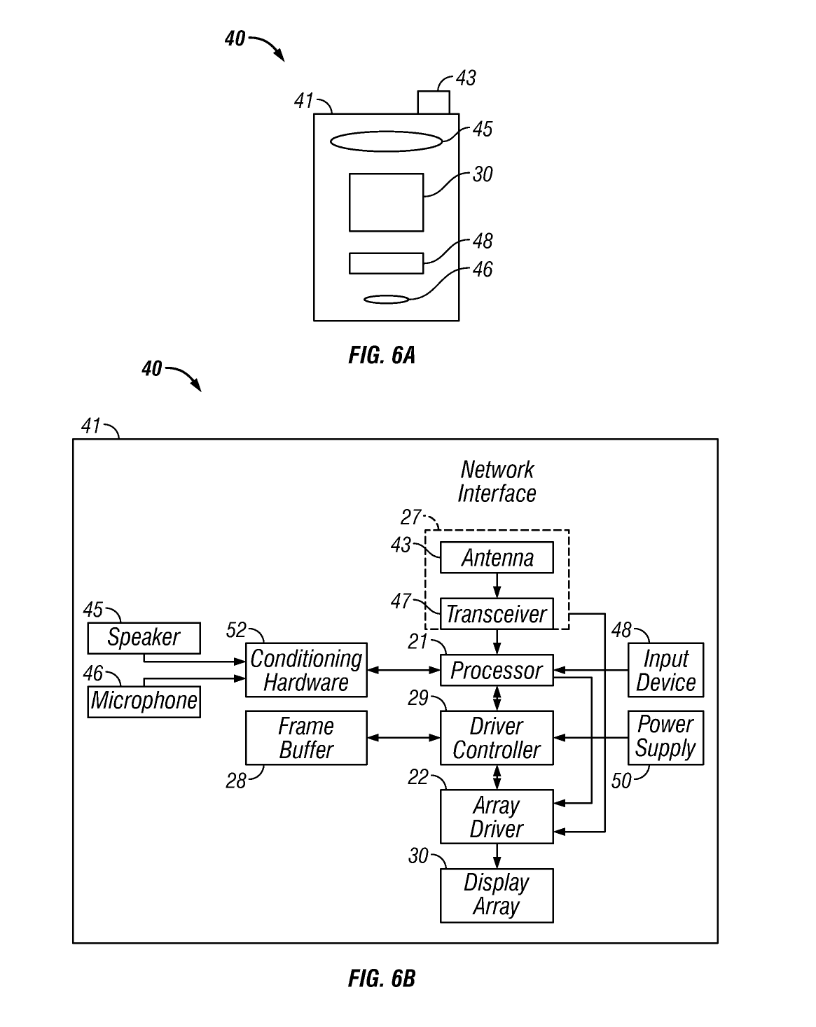

FIGS. 4 and 5 illustrate one possible actuation protocol for driving an array of electromechanical devices such as an array of interferometric modulators. FIG. 4 illustrates a possible set of column and row voltage levels that may be used for modulators exhibiting the hysteresis properties illustrated in FIG. 3. In the embodiment of FIG. 4 (also see FIG. 5A), as many as five or more possible voltages may be applied along a common line (which may be either a row or column line, in various embodiments) in order to address specific common lines, and at least two possible voltages may be applied along segment lines to write data to the common line(s) currently being addressed.

When a release voltage VC_{REL} is applied along a common line, all interferometric modulator elements along the common line will be placed in a relaxed state, alternatively referred to as a released or unactuated state, regardless of the voltage applied along the segment lines. The release voltage VC_{REL} and the high and low segment voltages VS_{H} and VS_{L} are selected accordingly. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line. The difference between the high and low segment voltage, also referred to as the segment voltage swing, is less than the width of the relaxation window.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. VC_{HOLD}_{_{—}}_{H} and VC_{HOLD}_{_{—}}_{L} may also be referred to as a positive and negative hold voltage respectively. A relaxed modulator will remain in a relaxed position, and an actuated modulator will remain in an actuated position. The hold voltages are selected such that the pixel voltage will remain within a stability window of the interferometric modulator both when the high segment voltage VS_{H} and the low segment voltage VS_{L} are applied along the corresponding segment line. The segment voltage swing is thus less than the width of either the positive or the negative stability window.

When an addressing voltage is applied on a common line, such as high addressing voltage VC_{ADD}_{_{—}}_{H} or low addressing voltage VC_{ADD}_{_{—}}_{L}, data can be selectively written to the modulators along that line by application of segment voltages along the respective segment lines. VC_{ADD}_{_{—}}_{H} and VC_{ADD}_{_{—}}_{L}, may also be referred to as positive and negative address voltages respectively. The addressing voltages are selected such that when an addressing voltage is applied along a common line, the pixel voltage will be within a stability window when one of the segment voltages is applied along the segment line, but beyond the stability window when the other is applied, causing actuation of the pixel. The particular segment voltage which causes actuation will vary depending upon which addressing voltage is used. When the high addressing voltage VC_{ADD}_{_{—}}_{H} is applied along the common line, application of the high segment voltage VS_{H} will cause a modulator to remain in its current position, while application of the low segment voltage VS_{L} causes actuation of the modulator. The effect of the segment voltages will be the opposite when a low addressing voltage VC_{ADD}_{_{—}}_{L} is applied, with high segment voltage VS_{H} causing actuation of the modulator, and low segment voltage VS_{L} having no effect on the state of the modulator.

In certain embodiments, only a high or a low hold voltage and address voltage may be used. Using both positive and negative hold and address voltages, however, allows the polarity of write procedures to be alternated, inhibiting charge accumulation which could occur after write operations of only a single polarity.

FIG. 5B is a timing diagram showing a series of common and segment voltage signals applied to the 3×3 array of FIG. 2 which will result in the display arrangement illustrated in FIG. 5A, where actuated modulators are non-reflective and illustrated as dark. Prior to writing the frame illustrated in FIG. 5A, the pixels can be in any state, but the write procedure illustrated in the timing diagram of FIG. 5B releases each modulator in a given common line prior to addressing the common line.

During the first line time 60a, none of common lines 1, 2, or 3 are being addressed. A release voltage 70 is applied on common line 1. The voltage applied on common line 2 begins at a high hold voltage 72 and moves to a release voltage 70. A low hold voltage 76 is applied along common line 3. Thus, the modulators (1,1), (1,2), and (1,3) along common line 1 remain in a relaxed state for the duration of the first line time 60a, the modulators (2,1), (2,2), and (2,3) along common line 2 will move to a relaxed state, and the modulators (3,1), (3,2), and (3,3) along common line 3 will remain in their previous state. The segment voltages applied along segment lines 1, 2, and 3 will have no effect on the state of the interferometric modulators, as none of common lines 1, 2, or 3 are being addressed during line time 60a.

During the second line time 60b, the voltage on common line 1 moves to a high hold voltage 72, and all modulators along common line 1 remain in a relaxed state regardless of the segment voltage applied. The modulators along common line 2 remain in a relaxed state, and the modulators (3,1), (3,2), and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the positive stability window of the modulators, and modulators (1,1) and (1,2) are actuated. Because a high segment voltage 62 is applied along segment line 3, the pixel voltage across modulator (1,3) is less than that of modulators (1,1) and (1,2), and is within the positive stability window of the modulator. Modulator (1,3) thus remains relaxed. Also during line time 60c, the voltage along common line 2 decreases to a low hold voltage 76, and the voltage along common line 3 remains at a release voltage, leaving the modulators along common lines 2 and 3 in a relaxed position.

During the fourth line time 60d, the voltage on common line 1 is at a high hold voltage 72, leaving the modulators along common line 1 in their respective addressed states. Common line 2 is now addressed by decreasing the voltage on common line 2 to a low address voltage 78. Because a high segment voltage 62 is applied along segment line 2, the pixel voltage across modulator (2,2) is below the negative stability window of the modulator, causing the modulator (2,2) to actuate. Because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage, leaving the modulators along common lines 1 and 2 in their respective addressed states. The voltage on common line 3 increases to a high address voltage to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth hold time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, it can be seen that a given write procedure includes the use of either high hold and address voltages, or low hold and address voltages. Once a high or low hold voltage is applied, the pixel voltage remains within or beyond a given stability window, and does not pass through the relaxation window until a release voltage is applied. Furthermore, as each modulator is released as part of the write procedure prior to addressing the modulator, the actuation time of a modulator, rather than the release time, determines the necessary line time. In embodiments in which the release time of a modulator is greater than the actuation time, the release voltage may be applied for longer than a single line time, as depicted in FIG. 5B. In further embodiments, voltages applied along common lines or segment lines may vary to account for variations in the actuation and release voltages of different modulators, such as modulators of different colors.

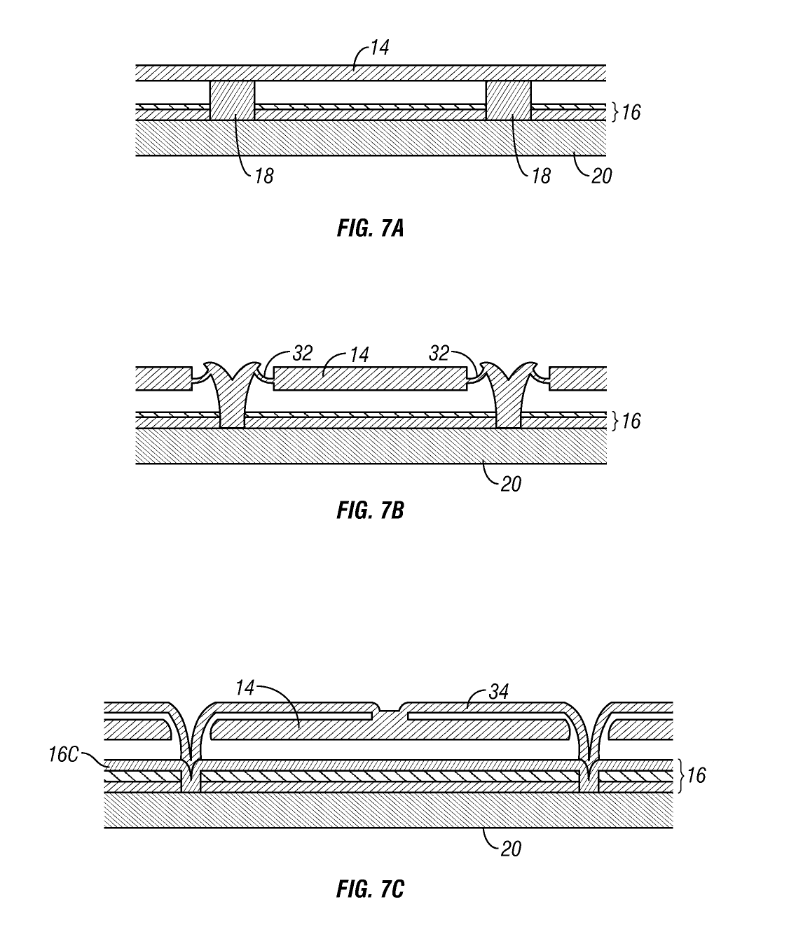

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

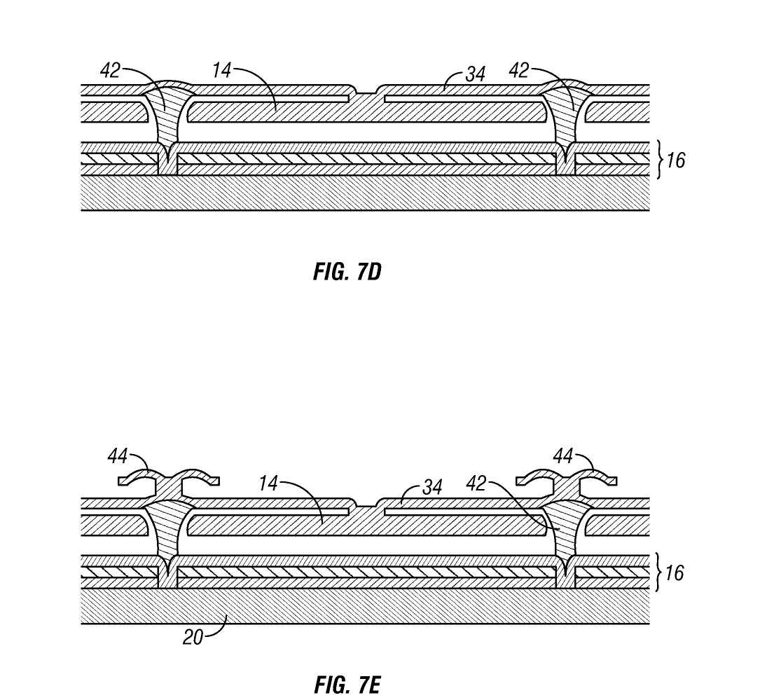

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Some of the embodiments of the invention relate to an apparatus and methods for selecting an update schedule or order for the common lines. When updating a display, a significant amount of the power consumed may be expended in changing the voltage level on the segment lines. Thus, to reduce power consumption, it may be desirable to decrease the amount of voltage switching on the segment lines. As described below, by manipulation of the update order of the common lines, it may be possible to reduce the amount of voltage switching on the segment lines.

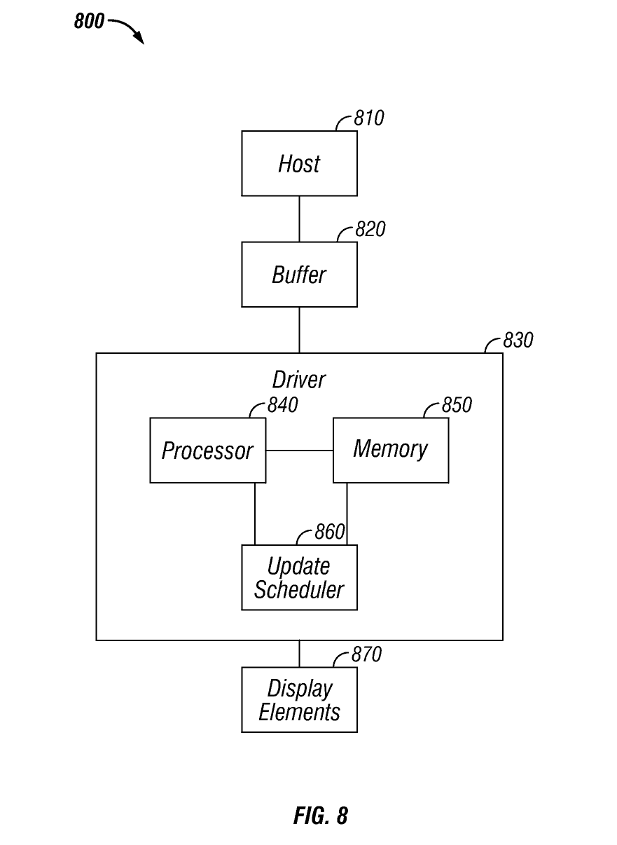

FIG. 8 is a system block diagram illustrating an embodiment of a display apparatus 800. Certain elements of FIG. 8 are similar to corresponding elements of FIG. 6B. In particular, host 810 may include the functionality of processor 21, driver controller 29, and conditioning hardware 52. Further, buffer 820 is similar in functionality to frame buffer 28, driver 830 is similar to array driver 22, and display elements 870 are similar to display array 30. In function, host 810 receives display data and transfers the display data to buffer 820. Buffer 820 stores display data from host 810 until driver 830 is ready to display the display data. Driver 830 retrieves the display data from buffer 820 and causes display elements 870 to display the display data. In one embodiment, display elements 870 are a plurality of EMS devices organized into rows and columns. This arrangement is similar to the rows and columns illustrated in FIG. 2 and its accompanying text. As described above, the rows may be referred to as common lines and the columns may be referred to as segment lines. The driver 830 comprises a processor 840, a memory 850, and an update scheduler 860. In one embodiment, update scheduler 860 operates in conjunction with the processor 840 and the memory 850 to retrieve display data from the buffer 820 and to cause update the display elements 870 with the display data. As described below, the update scheduler 860 may rearrange the order in which rows of the display elements 870 are updated. For example, while the host 810 may place display data in the buffer 820 in a particular order, such as sequentially from a first row of display to a last row of display data, the update scheduler 860 may alter the order in which the display data is displayed on the display elements 870. In one embodiment, the update scheduler may dynamically reorder the update schedule for display data. In another embodiment, the update order may be pre-determined and may be used for multiple or all updates of the display apparatus. Advantageously, selective reordering may result in decreased power consumption for the display apparatus 800.

While the constituent elements of display apparatus 800 have been illustrated as functionally separate, one or more of host 810, buffer 820, and driver 830 may share common physical resources such as processing or memory capabilities. Further, while the update scheduler 860 has been illustrated as a component of the driver 830, the functionality of the update scheduler may be implemented in the host 810 as well. For example, rather than the reordering being performed by the driver 830 on display data retrieved from the buffer 820, the host 810 may reorder the display data prior to storing it in the buffer 820.

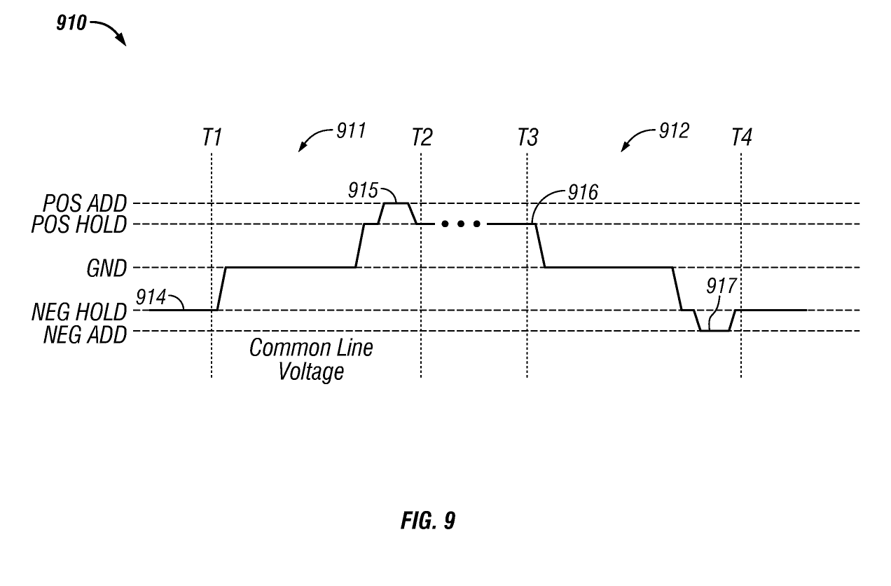

FIG. 9 is an exemplary timing diagram illustrating a voltage waveform 910 on a common line as the waveform 910 varies over time. The common line may correspond to a row of display elements 870 of FIG. 8. As described above with respect to FIG. 5B, the voltage level on the common line may vary between a plurality of voltage levels. These voltages may include a negative address voltage, negative hold voltage, ground voltage, positive hold voltage, and positive address voltage. The time period between time T1 and time T2 where the waveform 910 varies between voltage levels may be referred as a first update period 911. Similarly, the time period between time T3 and T4 where the waveform varies between voltage levels may be referred to as a second update period 912. During the first update period 911, the waveform 910 begins at the negative hold voltage as indicated by waveform segment 914. However, the address voltage level used during the first update period 911 is the positive address voltage as shown in waveform segment 915. Each common line may be referred to as having a certain polarity during an update period. The polarity of the common line will be described herein as being positive if a positive address voltage is used on the common line during an update period. Further, the polarity of the common line will be described herein as being negative if a negative address voltage level is used on the common during an update period. Thus, during the first update period 911, the common line may be described as having a positive polarity. Similarly, during the second update period 912, the waveform 910 begins at a positive hold voltage level as shown by waveform segment 916. During the second update, the negative address voltage level is used as shown by waveform segment 917. Accordingly, during the second update period 912, the common line may be referred to as having a negative polarity. In addition to a polarity, each common line may also be associated with a color such as red, green, or blue. For example, the interferometric modulators in a particular row may be constructed and controlled in order to reflect or absorb light of a particular wavelength, such as a wavelength corresponding to the color red. In one embodiment, as described below, the order in which the rows of display apparatus are updated may be determined based upon characteristics of the common lines in the display apparatus such as polarity and color. Advantageously, the modified update order may reduce power consumption by decreasing the amount of voltage changes on the segment lines.

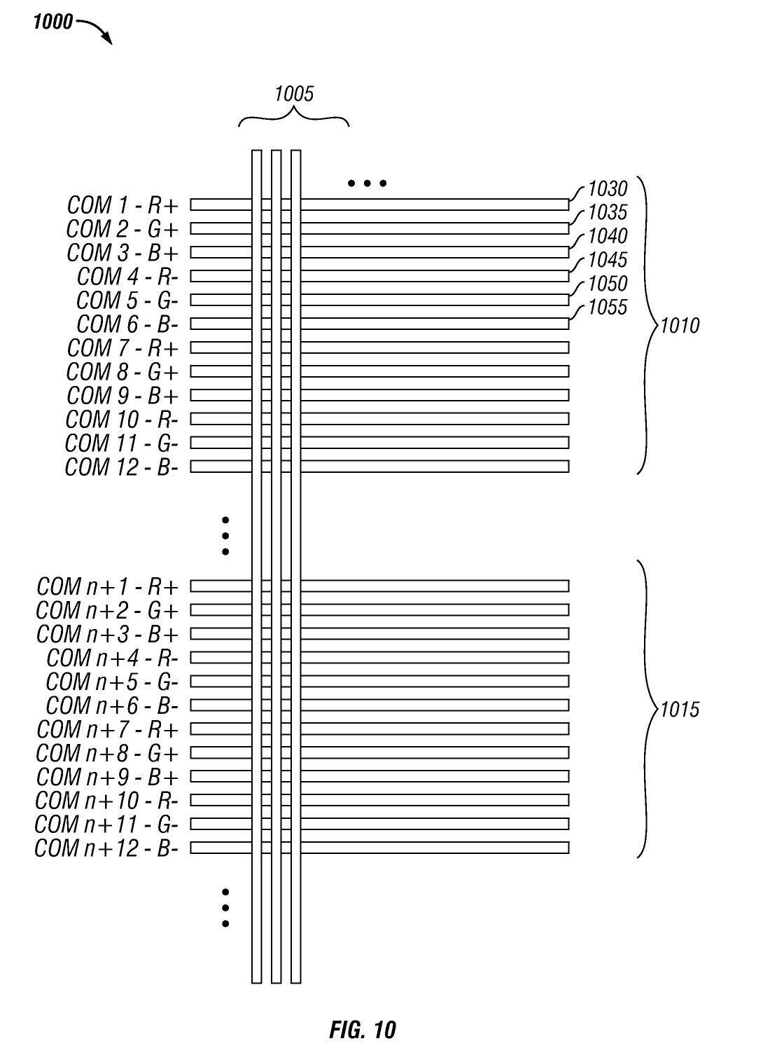

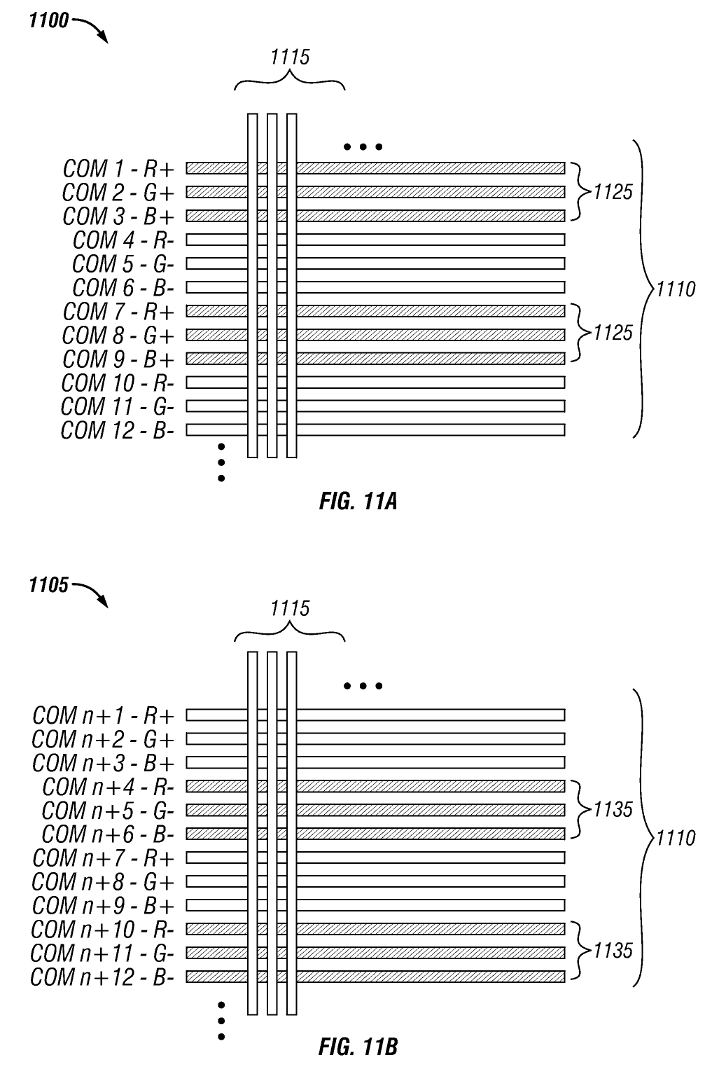

FIG. 10 is a system block diagram 1000 illustrating a portion of the display elements of FIG. 8. As described herein, an improved update order may make use of update sections and update groups within update sections. FIG. 10 illustrates update sections. FIGS. 11-13 illustrate update groups within an update section. Update sections help facilitate an improved update order while limiting the amount and severity of visual artifacts. As described above in relation to FIG. 8, the display data to be displayed is stored into a buffer 820 before it is written to the display elements 870. The buffer 820 has a finite capacity and may not store all the data required for an update in memory at the same time. Rather, only a limited amount of display data may be available at any given time in the buffer 820. Thus, even if it were beneficial to sequentially write data to a particular pair of common lines, doing so may result in visual artifacts or tearing if the data for each common line in the particular pair is not in the buffer 820. Indeed, if the updated display data for a common line is not available when the driver 830 goes to fetch the display data from the buffer 820, incorrect display data may be retrieved and displayed on the common line. Visually, this may appear to an observer as a tearing of the displayed image. Advantageously, as described below, update sections may be used in order to avoid visual artifacts such as tearing. Diagram 1000 illustrates a plurality of segment lines 1005. As indicated by the ellipses, segment lines 1005 may constitute only a fraction of the segment lines of the entire display apparatus. Diagram 1000 also illustrates a number of common lines such as common lines 1030, 1035, 1040, 1045, 1050, and 1055. As shown, each common line may be associated with a color and polarity. For example, common line 1030 may be associated with the color red and with the positive polarity during a particular update period. Similarly, the common line 1035 may be associated with the color green and with the positive polarity during the same update period. Other polarity patterns among the common lines are possible. For example, rather than switching polarity every three common lines, i.e. lines 1030, 1035, and 1040, positive and 1045, 150, and 155 negative, the polarity of the common lines could switch every common line, every other common line, randomly between lines, or according to some other scheme.

The common lines may be grouped into update sections, such as a first update section 1010 and second update section 1015. Each update section may include a plurality of common lines. In one embodiment, each update section comprises approximately thirty common lines. In another embodiment, each update section comprises a number of common lines that is a multiple of the number of colors which may be associated with a common line such as the three colors red, green, and blue. In another embodiment, the number of common lines in an update section may be a multiple of the number of polarities which may be associated with the common lines such as the two polarities, positive and negative, described above. In another embodiment, the number of common lines in an update section may be a multiple of both the number of colors and the number of polarities. In another embodiment, the number of common lines in an update section may be selected such the number of common lines in the section is proportional to the number of lines for which updated display data is available in the buffer.

In one embodiment, the common lines in an update section may be sequential. For example, as illustrated, update section may comprise common lines 1030, 1035, 1040, and so on until a last sequential common line. In an alternative embodiment, an update section may comprise non-sequential common lines. For example, an update might comprise every other common line for a given portion of the common lines in the display apparatus. Other groupings are also possible. However, for the sake of explanation, update sections will be described as comprising sequential common lines. As described below, in one embodiment, the reordering of common lines is arranged such that each of the common lines in one update section is updated before the common lines in another update section. For example, each of the common lines, e.g., 1030, 1035, 1040, etc. . . . in the first update section 1010 may be updated before any of the common lines of the second update section 1015 are updated. Advantageously, by limiting the reordering to common lines within a current update section and by choosing an appropriate update section size, the problem of retrieving old and incorrect display data can be diminished. For example, if more than 30 lines of updated display data is kept in the buffer, then with an update section comprising about 30 lines, it may be possible to update any pair of common lines in the update section without tearing or other artifacts. After updating each common line in the first update section 1010, each common line in a subsequent update section, such as the second update section 1015, may be updated. In this manner, update section by update section, the entire display apparatus may be updated.

FIGS. 11A and 11B illustrate an exemplary update schedule for a portion of the display elements of FIG. 8. FIGS. 11A and 11B illustrate an update section 1110 having a plurality of common lines. A plurality of segment lines 1115 is also shown. As described above, the common lines of the display elements apparatus may be logically separated into a plurality of update sections such as the update section 1110. Each of the update sections may be further logically separated into a plurality of update groups. An update group comprises one or more of the common lines in an update section having a similar characteristic. In FIG. 11A, a first update group 1125 is illustrated. As shown, the first update group 1125 comprises all the common lines in the update section 1110 having the same, positive polarity. In FIG. 11B, a second update group 1135 is illustrated. The second update group 1135 comprises all the common lines in the update section having the same, negative polarity. In one embodiment, the update order for the common lines in the update section 1110 is arranged such that each of the common lines in the first update group 1125 is updated before any of the common lines in the second update group 1135. As described above, a significant amount of energy is expended when switching the voltage being applied to the segment lines 1115. Accordingly, it is advantageous to update common lines in an order that minimizes the amount of voltage switching done on the segment lines between common line updates. In particular, it is advantageous to select an order for updating common lines that increases the likelihood that the last common line update will use similar segment line voltages as the next common line update. In one embodiment, this may be achieved by grouping the common lines into update groups which share the types of characteristics described herein. For example, where two common lines share the same polarity during an update, there is an increased likelihood that the voltage for a particular segment line will not need to change when updating each of the two common lines in succession. Thus, the power consumed during the updates may decrease. The common lines within each update group may be updated sequentially, in random order, or according to some other order. For example, it may be possible to analyze the common lines in an update group and determine an update order within the group which minimizes the number of segment voltage changes. This operation may be performed by the update scheduler.

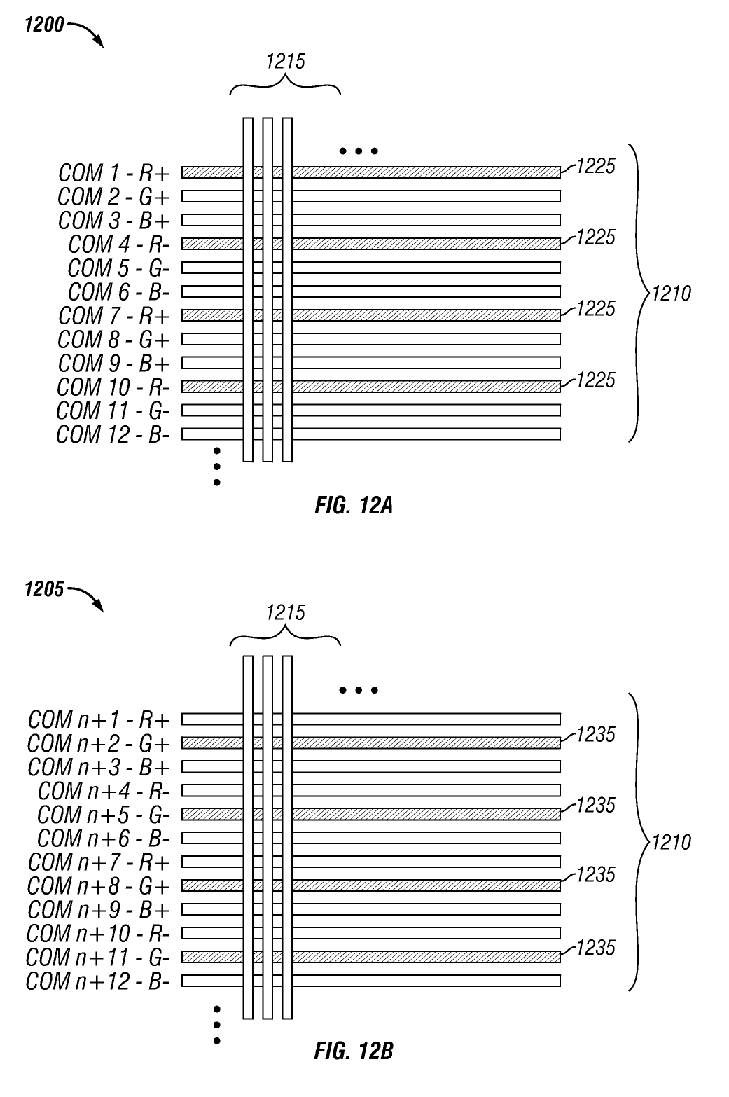

FIGS. 12A and 12B illustrate another exemplary update schedule for a portion of the display elements of FIG. 8. FIGS. 12A and 12B illustrate an update section 1210 having a plurality of common lines. A plurality of segment lines 1215 is also shown. In FIG. 12A, a first update group 1225 is illustrated. As shown, the first update group 1225 comprises all the common lines in the update section 1210 having the same red color. In FIG. 12B, a second update group 1235 is illustrated. The second update group 1235 comprises all the common lines in the update section having the same green color. Though not shown, the update section 1210 may also include a third update group comprising all of the common lines in update section 1210 having the same blue color. As described above, the order in which to select update groups and the order in which to update common lines within an update group may be changed from the order shown and described herein. As with the example of polarity described above, where two common lines share the same color, there is an increased likelihood that the voltage for a particular segment line will remain the same when updating the two common lines in succession. Thus, the power consumed during the updates may decrease.

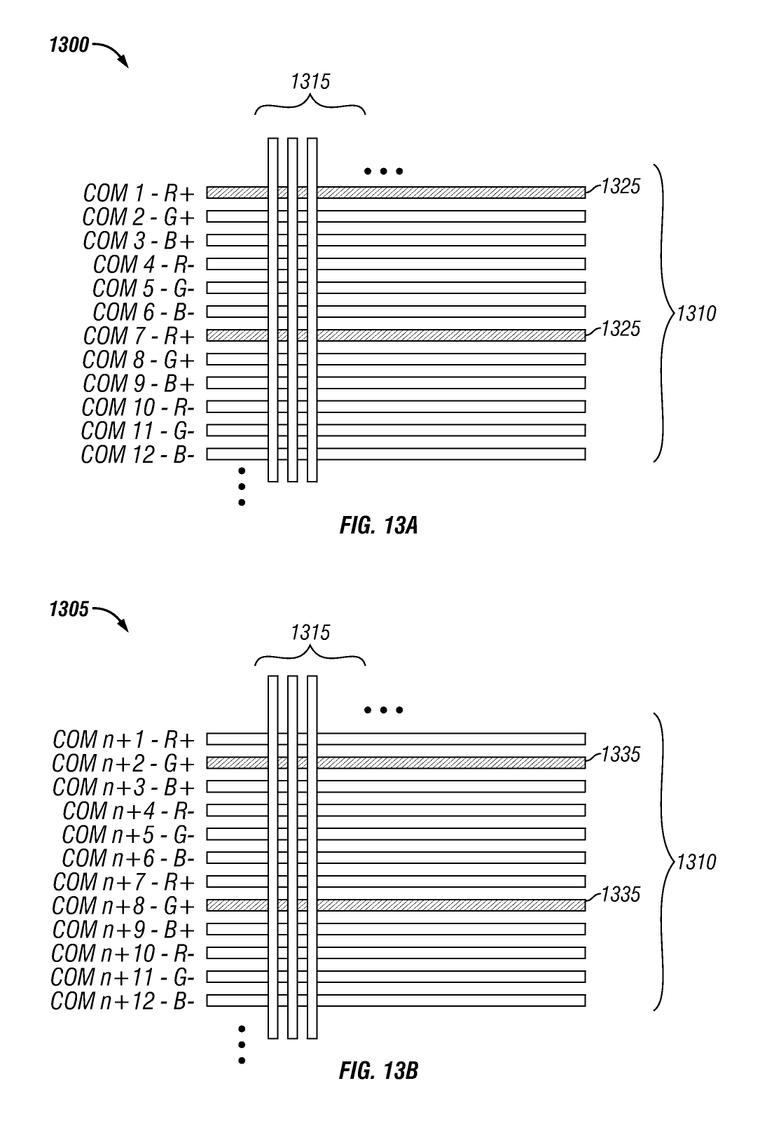

FIGS. 13A and 13B illustrate another exemplary update schedule for a portion of the display elements of FIG. 8. FIGS. 13A and 13B illustrate an update section 1310 having a plurality of common lines. A plurality of segment lines 1315 is also shown. In FIG. 13A, a first update group 1325 is illustrated. As shown, the first update group 1325 comprises all the common lines in the update section 1310 having the same red color and positive polarity. In FIG. 13B, a second update group 1335 is illustrated. The second update group 1335 comprises all the common lines in the update section 1310 having the same green color and positive polarity. Though not shown, the update section 1310 may also include a update groups comprising the remaining combinations of color and polarity (red negative, green negative, and blue positive and negative). As described above, the order in which to select update groups and the order in which to update common lines within an update group may be changed from the order shown and described herein. As with the examples of just polarity and just color described above, where two common lines share the same color and polarity, there is an increased likelihood that the voltage for a particular segment line will remain the same when updating the two common lines in succession. Thus, the power consumed during the updates may decrease.

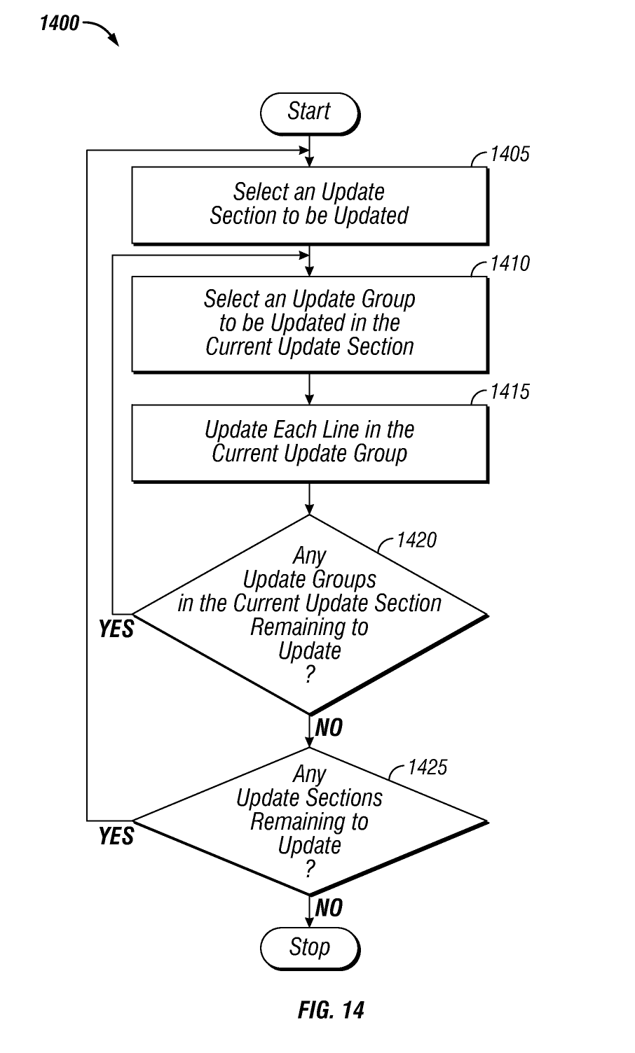

FIG. 14 is a flowchart of an embodiment of a process 1400 of updating the display elements of FIG. 8. Initially, an update section is selected for update as shown in step 1405. The selected update section may be referred to as the current update section. As described above, the update sections may be predefined, e.g., sets of approximately thirty common lines, or they may be determined dynamically based on the processing capabilities of the host and driver or on the size and status of the buffer holding display data. After an update section is selected, an update group within the current update section is selected as shown in step 1410. The selected update group may also be referred to as the current update group. As described above, the update groups may comprise one or more common lines in the current update section that have one or more similar characteristics. For example, each common line having the same polarity, color, or both may form an update group. After selecting a current update group, each common line in the update group is updated as shown in step 1415. As described above, the common lines within each update group may be updated sequentially, in random order, in an order selected to decrease power consumption, or in some other order. In some drive schemes, certain common lines may even be skipped rather than being updated. After the common lines in the current update group have been updated, it is determined whether there are any additional update groups to update in the current update section as shown in step 1420. If so, the process 1400 returns to step 1410 and a new update group in the current update section is selected. If not, the process 1400 continues to step 1425 and a determination is made as to whether any additional update sections remain to be updated. If so, the process 1400 returns to step 1405 and a new update section is selected. If not, the entire display has been updated and the process 1400 stops as shown. Advantageously, the process 1400 increases the likelihood that the common lines will be updated in an order that reduces the amount of voltage switching on the segment lines between updates and thus reduces power consumption in the update process.

What is claimed is:

1. A method of updating a display, the display comprising a plurality of display elements arranged as a plurality of lines, each line having an associated color and polarity, the method comprising:
updating one or more update sections of the display, an update section of the one or more update sections comprising one or more lines, wherein the one or more lines of the update section are grouped as one or more update groups, each update group comprising a subset of the one or more lines having one or more common characteristics;
wherein updating the update section comprises updating each update group of the one or more update groups in the update section;
wherein updating each update group comprises updating each line in the subset of the one or more lines in the update group.

2. The method of claim 1, wherein the one or more common characteristics comprise an associated color.

3. The method of claim 1, wherein the one or more common characteristics comprise an associated polarity.

4. The method of claim 1, wherein the update section comprises approximately 30 lines.

5. The method of claim 1, wherein each update group comprises approximately 5 lines.

6. The method of claim 1, wherein the one or more lines in the update section are adjacent.

7. The method of claim 1, wherein the subset of the one or more lines in each update group are at least partially non-adjacent.

8. The method of claim 1, wherein each line in the plurality of lines comprises a row or column.

9. The method of claim 1, wherein the display elements comprise bi-stable devices.

10. The method of claim 1, wherein the display elements comprise interferometric modulators.

11. A display apparatus comprising:
a plurality of display elements arranged as a plurality of lines; and,
a processor coupled to the plurality of display elements, wherein the processor is configured to update one or more update sections of the plurality of display elements, an update section of the one or more update sections comprising one or more lines, wherein the one or more lines of the update section are grouped as one or more update groups, each update group comprising a subset of the one or more lines having one or more common characteristics;
wherein updating the update section comprises updating each update group of the one or more update groups in the update section;
wherein updating each update group comprises updating each line in the subset of the one or more lines in the update group.

12. The apparatus of claim 11, wherein the one or more common characteristics comprise an associated color.

13. The apparatus of claim 11, wherein the one or more common characteristics comprise an associated polarity.

14. The apparatus of claim 11, wherein the update section comprises approximately 30 lines.

15. The apparatus of claim 11, wherein each update group comprises approximately 5 lines.

16. The apparatus of claim 11, wherein the one or more lines in the update section are adjacent.

17. The apparatus of claim 11, wherein the subset of the one or more lines in each update group are at least partially non-adjacent.

18. The apparatus of claim 11, wherein each line in the plurality of lines comprises a row or column.

19. The apparatus of claim 11, wherein the display elements comprise bi-stable devices.

20. The apparatus of claim 11, wherein the display elements comprise interferometric modulators.

21. A display apparatus comprising:
means for displaying data; and
means for updating one or more update sections of the display means, an update section of the one or more update sections comprising one or more lines, wherein the one or more lines of the update section are grouped as one or more update groups, each update group comprising a subset of the one or more lines having one or more common characteristics;
wherein the means for updating the update section comprises means for updating each update group of the one or more update groups in the update section;
wherein the means for updating each update group comprises means for updating each line in the subset of the one or more lines in the update group.

22. A computer-readable medium having stored thereon, computer executable instructions that, if executed by an apparatus, cause the apparatus to perform a method comprising:
updating one or more update sections of a display, an update section of the one or more update sections comprising one or more lines, wherein the one or more lines of the update section are grouped as one or more update groups, each update group comprising a subset of the one or more lines having one or more common characteristics;
wherein updating the update section comprises updating each update group of the one or more update groups in the update section;
wherein updating each update group comprises updating each line in the subset of the one or more lines in the update group.
